(19) United States
(12) Patent Application Publication
(10) Pub. No.: US 2009/0098428 A1
(43) Pub. Date: Apr. 16, 2009

(54) FUEL CELL SYSTEM

(76) Inventors: Chih-Yen Lin, Taipei County (TW); Yu-Chun Ko, Taoyuan County (TW); Yu-Chih Lin, Kao-Hsiung City (TW); Chiang-Wen Lai, Tao-Yuan City (TW); Jiun-Ming Chen, Taipei County (TW); Ching-Sen Yang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/935,414

(22) Filed: Nov. 6, 2007

(30) Foreign Application Priority Data
Oct. 15, 2007 (TW) 096138495

(51) Int. Cl. H01M 8/02

(52) U.S. Cl. 429/26; 429/34

(57) ABSTRACT

A fuel cell system includes a fuel cell stack consisting of a plurality of fuel cell units, a flow-distributing device, and a flow-confluence device; a fuel container; a housing encompassing and protecting the fuel cell stack and the fuel container; and a fan mounted on the housing for providing air to the cathodes of the fuel cell units. The fuel cell units have liquid inlet and liquid outlet, which are connected with the flow-distributing device and the flow-confluence device respectively.

### BACKGROUND OF THE INVENTION

1. Field of the Invention

The present invention relates generally to a fuel cell technology and, more particularly, to a fuel cell system that employs a novel flow-distributing device and a flow-confluence device. The present invention fuel cell system is suited for charging batteries of various 3C products such as mobile phones or computers.

2. Description of the Prior Art

As known in the art, a fuel cell is an electrochemical cell in which a free energy change resulting from a fuel oxidation reaction is converted into electrical energy. Fuel cells utilizing methanol as fuel are typically named as Direct Methanol Fuel cells (DMFCs), which generate electricity by combining gaseous or aqueous methanol with air.

Fuel cells, like ordinary batteries, provide dc electricity from two electrochemical reactions. These reactions occur at electrodes (or poles) to which reactants are continuously fed. The negative electrode (anode) is maintained by supplying fuel such as methanol, whereas the positive electrode (cathode) is maintained by the supply of air.

When providing current, methanol is electrochemically oxidized at the anode electrocatalyst to produce electrons, which travel through the external circuit to the cathode electrocatalyst where they are consumed together with oxygen in a reduction reaction. The circuit is maintained within the cell by the conduction of protons in the electrolyte.

One molecule of methanol (CH₃OH) and one molecule of water (H₂O) together store six atoms of hydrogen. When fed as a mixture into a DMFC, they react to generate one molecule of CO₂, 6 protons (H⁺), and 6 electrons to generate a flow of electric current. The protons and electrons generated by methanol and water react with oxygen to generate water.

In general, fuel cells are made from many basic cell units. These basic cell units are typically connected in series to output a required operating voltage.

The fuel cell module usually includes a current collector (also referred to as charge collector board) and a flow board, which both play important roles. The current collector collects the electrons generated from the electron-chemical reaction, and the flow board manages and controls the distribution of the fuel. In the past, the flow board design has focused on enabling fuel to pass smoothly through the fuel channel into the membrane electrode assembly (MEA).

### SUMMARY OF THE INVENTION

It is one object of the present invention to provide an improved fuel cell system with better performance and is suited for charging batteries of various 3C products.

According to the claimed invention, a fuel cell system comprised a fuel cell stack consisting of a plurality of fuel cell units, a flow-distributing device, and a flow-confluence device, wherein the plurality of fuel cell units are fixed and sandwiched between the flow-distributing device and the flow-confluence device; a fuel container for storing anode fuel, wherein the fuel container has a fuel outlet that is connected to the flow-distributing device and a fuel inlet that is connected to the flow-confluence device; a housing encompassing and protecting the fuel cell stack and the fuel container; and a fan mounted on the housing for providing cathode fuel to the fuel cell units and dissipating heat.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of a fuel cell system in accordance with the first preferred embodiment of this invention.

FIG. 2 is an exploded diagram of a fuel cell stack of FIG. 1 according to the first preferred embodiment of this invention.

FIG. 3 is a schematic diagram illustrating a side view of exemplary 2-Watt fuel cell module in accordance with this invention.

FIG. 4 is a perspective view illustrating an internal configuration of a fuel cell system in accordance with the second preferred embodiment of this invention.

FIG. 5 is a perspective view illustrating an internal configuration of a fuel cell system in accordance with the third preferred embodiment of this invention.

FIG. 6 is a perspective view illustrating an internal configuration of a fuel cell system in accordance with the fourth preferred embodiment of this invention.

### DETAILED DESCRIPTION

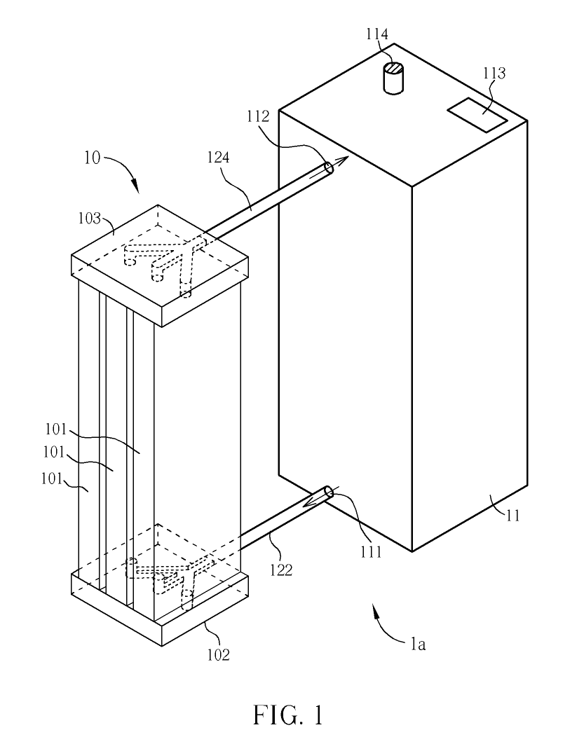

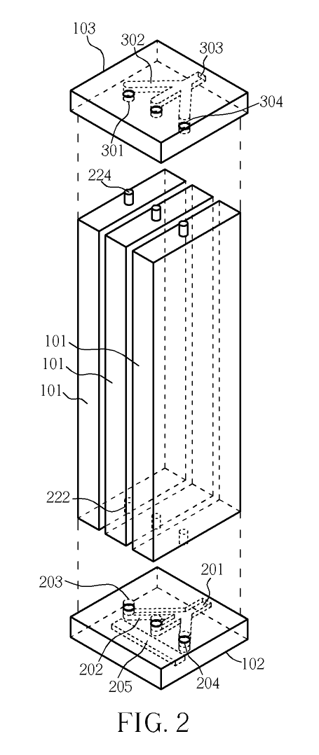

Please refer to FIG. 1 and FIG. 2, wherein FIG. 1 is a perspective view of a fuel cell system in accordance with the first preferred embodiment of this invention and FIG. 2 is an exploded diagram of a fuel cell stack of FIG. 1 according to the first preferred embodiment of this invention.

As shown in FIG. 1 and FIG. 2, the present invention fuel cell system 1a comprises at least one fuel cell stack 10 and a fuel container 11 connected to the fuel cell stack 10. The fuel cell stack 10 comprises a plurality of fuel cell units 101, a flow-distributing device 102 and a flow-confluence device 103. The plurality of fuel cell units 101 are mounted on the flow-distributing device 102 that, from one aspect, serves as a base, and are capped with the flow-confluence device 103. The plurality of fuel cell units 101 are sandwiched and fixed between the flow-distributing device 102 and the flow-confluence device 103. The flow-distributing device 102 is connected to the fuel container 11 through a conduit 122, while the flow-confluence device 103 is connected to the fuel container 11 through a conduit 124.

The fuel container 11 is used to store anode fuel, for example, methanol solution or hydrogen. According to this invention, the fuel container 11 is made of corrosion-resistive materials such as plastics, ceramics, metals, metal alloys or polymeric composites and so on.

According to the first preferred embodiment, the fuel container 11 includes a fuel outlet 111, a fuel inlet 112, a gas-liquid separator 113 and a fuel feed port or nozzle 114. The conduit 122 is connected to the fuel outlet 111, while the conduit 124 is connected to the fuel inlet 112. The gas-liquid separator 113 is used to expel gaseous reaction products such as carbon dioxide from the fuel container 11.

The fuel stored in the fuel container 11 equally flows into respective fuel cell units 101 through the conduit 122 and the flow-distributing device 102 in a gravity-feeding fashion. The reaction products such as water and carbon dioxide generated by each of the fuel cell units 101 and un-reacted fuel flows back to the fuel container 11 through the flow-confluence device 103 and the conduit 124.

According to the present invention, the flow-distributing device 102 and the flow-confluence device 103 equally dispense anode fuel to the plurality of fuel cell units 101 of the fuel cell stack 10. Another inventive function provided by the novel fuel dispensing pair consisting of the flow-distributing device 102 and the flow-confluence device 103 is to fix the fuel cell units 101 and to keep substantially equal spacing between the fuel cell units 101 of the fuel cell stack 10. Keeping adequate spacing between the fuel cell units 101 is important because cathode fuel such as air can rapidly reaches the cathode surface and heat generated by the fuel cell stack 10 can be dissipated efficiently. Additionally, by providing suitable spacing between the fuel cell units 101, accumulation of moisture in the fuel cell stack 10 can be avoided.

As shown in FIG. 2, the flow-distributing device 102 is a monolithic structure comprising a lateral manifold 201, split-flow conduits 202 and vertical fuel outlets 203. A flexible packing material 204 such as O-ring is disposed inside each of the vertical fuel outlets 203. Fuel inlet nozzles 222 of respective fuel cell units 101 are inserted into and fittingly jointed to the corresponding vertical fuel outlets 203 of the flow-distributing device 102 and is tightly sealed by the flexible packing material 204. According to the present invention, the flow-distributing device 102 may be composed of plastics, glasses, ceramics, metals, metal alloys or polymeric composites.

As previously mentioned, according to the first preferred embodiment of this invention, the anode fuel is gravity fed and cycles by means of fuel channel capillary action or thermal convection. In this regard, the present invention fuel cell system 1a does not require a pump. However, in another case, a pump may be used to pressurize the fed anode fuel into the flow-distributing device 102.

According to the experimental results and practical measurement, the present invention flow-distributing device 102 can effectively distribute anode fuel such that even flow rate at each vertical fuel outlet 203 can be reached. As previously mentioned, the fuel inlet nozzles 222 of respective fuel cell units 101 and vertical fuel outlets 203 of the flow-distributing device 102 are joined together and are sealed by the flexible packing material 204. The flexible packing material 204 can avoid fuel leakage. A temperature sensor 205 or other electronic devices for monitoring the performance of the fuel cell system 1a may be integrated with the flow-distributing device 102.

Likewise, the flow-confluence device 103 is a monolithic structure comprising a plurality of vertical fuel inlets 301, confluent conduits 302 and confluent fuel outlet 303. A flexible packing material 304 such as O-ring is disposed inside each of the vertical fuel inlets 301. Fuel outlet nozzles 224 of respective fuel cell units 101 are inserted into and fittingly jointed to the corresponding vertical fuel inlets 301 of the flow-confluence device 103 and is tightly sealed by the flexible packing material 304. According to the present invention, the flow-confluence device 103 may be composed of plastics, glasses, ceramics, metals, metal alloys or polymeric composites.

Analogously, a temperature sensor or other electronic devices for monitoring the performance of the fuel cell system 1a may be integrated with the flow-confluence device 103. Optionally, a switching valve (not shown) may be disposed at the lateral manifold 201 of the flow-distributing device 102 or at the confluent fuel outlet 303 of the flow-confluence device 103 for controlling the fuel flow.

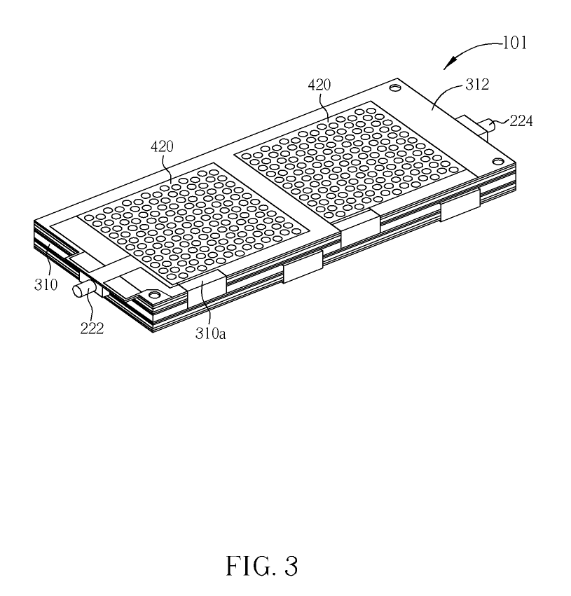

FIG. 3 is a schematic diagram illustrating a side view of exemplary 2-Watt fuel cell module (after assembly) in accordance with one preferred embodiment of this invention. It is understood that the fuel cell module 101 depicted in FIG. 3 is for illustration purpose only. The fuel cell module 101 may be other configurations or types. The fuel cell module 101 comprises an integrated anode flow board 310, a cathode board 312 (in contact with air), pre-molded adhesive plate, and MEA, which are laminated together. The fuel inlet nozzle 222 and the fuel outlet nozzle 224 are situated at two opposite sides of the integrated anode flow board 310. The anode charge collector (not shown) of the integrated anode flow board 310 is electrically connected with the cathode charge collector 420 of the cathode board 312 through a bendable conductive lug 310a.

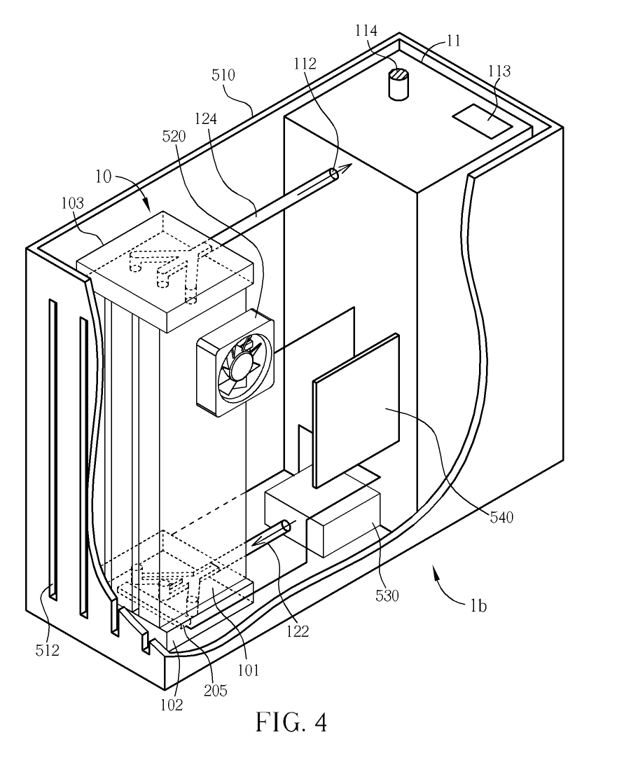

Please refer to FIG. 4. FIG. 4 is a perspective view illustrating an internal configuration of a fuel cell system 1b in accordance with the second preferred embodiment of this invention, wherein like numeral numbers designate like parts, areas or components. As shown in FIG. 4, the fuel cell system 1b comprises a fuel cell stack 10, a fuel container 11, a housing 510, a fan 520, a pump 530 and a power management device 540.

The housing 510 is used to accommodate and protect the fuel cell stack 10 and the fuel container 11. A plurality of substantially parallel slots 512 are provided on one sidewall of the housing 510 to help dissipate heat generated by the fuel cell stack 10 during operation.

Analogously, the fuel cell stack 10 comprises a plurality of fuel cell units 101, a flow-distributing device 102 and a flow-confluence device 103. The plurality of fuel cell units 101 are mounted on the flow-distributing device 102 and are capped with the flow-confluence device 103.

The flow-distributing device 102 is connected to the pump 530 through a conduit 122, while the flow-confluence device 103 is connected to the fuel container 11 through a conduit 124. The pump 530 is situated between the flow-distributing device 102 and the fuel container 11 to pump fuel into the plurality of fuel cell units 101.

The flow-distributing device 102 comprises a lateral manifold 201, split-flow conduits 202 and vertical fuel outlets 203. A flexible packing material 204 such as O-ring is disposed inside each of the vertical fuel outlets 203. The flow-confluence device 103 comprises a plurality of vertical fuel inlets 301, confluent conduits 302 and confluent fuel outlet 303. A flexible packing material 304 such as O-ring is disposed inside each of the vertical fuel inlets 301.

Fuel inlet nozzles of respective fuel cell units 101 are inserted into and fittingly jointed to the corresponding vertical fuel outlets 203 of the flow-distributing device 102 and is tightly sealed by the flexible packing material 204. Fuel outlet nozzles of respective fuel cell units 101 are inserted into and fittingly jointed to the corresponding vertical fuel inlets 301 of the flow-confluence device 103 and is tightly sealed by the flexible packing material 304.

A temperature sensor 205 or other electronic devices for monitoring the performance of the fuel cell system 1b may be integrated with the flow-distributing device 102 or the flow-confluence device 103. Optionally, a switching valve (not shown) may be disposed at the lateral manifold 201 of the flow-distributing device 102 or at the confluent fuel outlet 303 of the flow-confluence device 103 for controlling the fuel flow.

The fuel container 11 is used to store anode fuel such as methanol solution or hydrogen. The fuel container 11 comprises a fuel outlet (not explicitly shown), a fuel inlet 112, a gas-liquid separator 113 and a fuel feed port or nozzle 114. The aforesaid fuel outlet is directly connected to the pump 530.

The fuel stored in the fuel container 11 is pressurized by the pump 530 and is evenly distributed to the fuel cell units 101 through the conduit 122 and the flow-distributing device 102. The reaction products such as water and carbon dioxide generated by each of the fuel cell units 101 and un-reacted fuel flows back to the fuel container 11 through the flow-confluence device 103 and the conduit 124.

According to the experimental results and practical measurement, the flow-distributing device 102 can effectively distribute anode fuel such that even flow rate at each vertical fuel outlet 203 can be reached. The fuel inlet nozzles 222 of respective fuel cell units 101 and vertical fuel outlets 203 of the flow-distributing device 102 are joined together and are sealed by the flexible packing material 204. The flexible packing material 204 can avoid fuel leakage.

The flow-distributing device 102 and the flow-confluence device 103 fix the fuel cell units 101 and keep substantially equal spacing between the fuel cell units 101 of the fuel cell stack 10. Keeping adequate spacing between the fuel cell units 101 is important because cathode fuel such as air can rapidly reaches the cathode surface of each fuel cell unit 101. The heat generated by the fuel cell stack 10 can be dissipated efficiently. Additionally, by providing suitable spacing between the fuel cell units 101, accumulation of moisture in the fuel cell stack 10 can be avoided.

According to the second preferred embodiment of this invention, the power management device 540 is mounted on the housing 510. The power management device 540 may include a user operation interface, display panel and internal circuit including but not limited to printed circuit board, memory and chips. The fan 520, the pump 530 and the temperature sensor 205 are connected to power management device 540. When the temperature sensor 205 senses a temperature that exceeds a pre-set value, the power management device 540 activates the fan 520 to dissipate heat. The power management device 540 also controls the on/off states of the pump 530.

According to the second preferred embodiment of this invention, the fuel cell units 101 of the fuel cell stack 10 may be connected in series or in parallel by wire, welding or circuit integrated with the flow-distributing device 102 and the flow-confluence device 103. Additionally, the power management device 540 may connect to the fuel cell stack 10 to monitor the power output thereof.

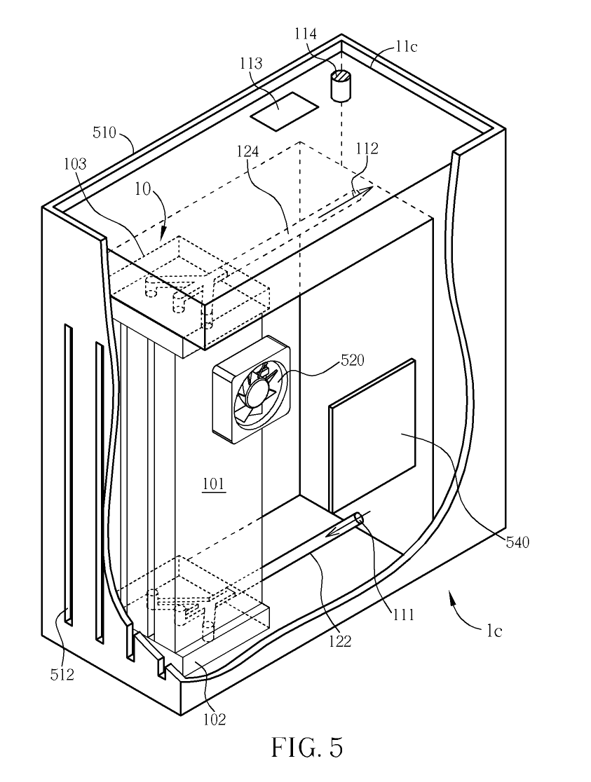

FIG. 5 is a perspective view illustrating an internal configuration of a fuel cell system 1c in accordance with the third preferred embodiment of this invention. As shown in FIG. 5, the fuel cell system 1c comprises a fuel cell stack 10, a reverse-L shaped fuel container 11c, a housing 510, a fan 520 and a power management device 540. The housing 510 is used to accommodate and protect the fuel cell stack 10 and the reverse-L shaped fuel container 11c. A plurality of substantially parallel slots 512 are provided on one sidewall of the housing 510 to help dissipate heat generated by the fuel cell stack 10 during operation.

The fuel cell system 1c is not equipped with a pump for pressurizing the fuel. The fuel stored in the reverse-L shaped fuel container 11c is fed to the fuel cell units 101 using gravity-feeding mechanism. The reverse-L shaped fuel container 11c can elongate feed period of fuel such that the fuel cell system 1c can work longer. In addition, the fuel container 11c may be other shapes, combinations of dual vessels or multiple vessels, wherein the vessels may comprise methanol vessel or pure water vessel.

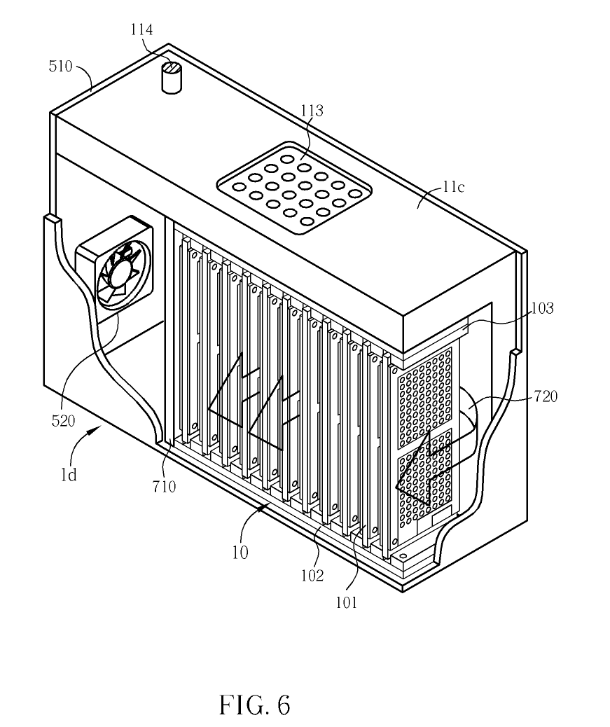

FIG. 6 is a perspective view illustrating an internal configuration of a fuel cell system 1d in accordance with the fourth preferred embodiment of this invention. As shown in FIG. 6, the fuel cell system 1d comprises a fuel cell stack 10, a reverse-L shaped fuel container 11c, a housing 510 and a fan 520. The housing 510 is used to accommodate and protect the fuel cell stack 10 and the reverse-L shaped fuel container 11c.

According to the fourth preferred embodiment of this invention, the fuel cell stack 10 includes sixteen fuel cell units 101, a flow-distributing device 102 and a flow-confluence device 103. The fuel cell units 101 are fix and sandwiched between the flow-distributing device 102 and the flow-confluence device 103. The flow-distributing device 102 is connected to the fuel container 11c through a fuel supply conduit (not explicitly shown), while the flow-confluence device 103 is connected to the fuel container 11c through a fuel return conduit (not explicitly shown).

According to the fourth preferred embodiment of this invention, the fan 520 is mounted on a side surface of the housing 510. A guide board 710 is situated between the fan 520 and the fuel cell stack 10. The guide board 710 guides the cool air blown from the fan 520 to the spacing between the fuel cell units 101 of the fuel cell stack 10 by way of the path 720. By doing this, heat-dissipating efficiency over the sixteen fuel cell units 101 is substantially equal and overheating of the fuel cell units on the farther side far from the fan 520 can be avoided.

Those skilled in the art will readily observe that numerous modifications and alterations of the device and method may be made while retaining the teachings of the invention.

What is claimed is:

1. A fuel cell system, comprising:
a fuel cell stack consisting of a plurality of fuel cell units, a flow-distributing device, and a flow-confluence device, wherein the plurality of fuel cell units are fixed and sandwiched between the flow-distributing device and the flow-confluence device;
a fuel container for storing anode fuel, wherein the fuel container has a fuel outlet that is connected to the flow-distributing device and a fuel inlet that is connected to the flow-confluence device;
a housing encompassing and protecting the fuel cell stack and the fuel container; and
a fan mounted on the housing for providing cathode fuel to the fuel cell units and dissipating heat.

2. The fuel cell system according to claim 1 wherein the flow-distributing device substantially equally distributes the anode fuel to the plurality of fuel cell units.

3. The fuel cell system according to claim 1 wherein the flow-distributing device and the flow-confluence device fix the fuel cell units and keep substantially equal spacing between the fuel cell units of the fuel cell stack, whereby cathode fuel can rapidly reaches cathode surface and heat generated by the fuel cell stack can be dissipated efficiently, and accumulation of moisture can be avoided.

4. The fuel cell system according to claim 1 wherein the flow-distributing device comprises a lateral manifold, split-flow conduits and vertical fuel outlets, and wherein the lateral manifold connects with the fuel container.

5. The fuel cell system according to claim 4 wherein a flexible packing material is disposed at each of the vertical fuel outlets.

6. The fuel cell system according to claim 5 wherein the flexible packing material includes O-ring.

7. The fuel cell system according to claim 4 wherein a temperature sensor is integrated with the flow-distributing device or the flow-confluence device.

8. The fuel cell system according to claim 1 wherein the flow-confluence device comprises a plurality of vertical fuel inlets, confluent conduits and confluent fuel outlet, and wherein the confluent fuel outlet connects to the fuel container.

9. The fuel cell system according to claim 1 wherein the anode fuel comprises methanol solution or hydrogen.

10. The fuel cell system according to claim 1 wherein the cathode fuel comprises air.

11. The fuel cell system according to claim 1 wherein the anode fuel flows into the fuel cell units by gravity feeding mechanism.

12. The fuel cell system according to claim 1 wherein the fuel cell system further comprises a pump between the flow-distributing device and the fuel container.

13. The fuel cell system according to claim 1 wherein the fuel cell system further comprises a power management device.

14. The fuel cell system according to claim 1 wherein the fuel container comprises reverse-L shaped fuel containers and combinations of dual vessels or multiple vessels.

15. The fuel cell system according to claim 1 wherein the fuel container further comprises a gas-liquid separator.

16. The fuel cell system according to claim 1 wherein the fuel container further comprises a fuel feed port.

17. The fuel cell system according to claim 1 wherein the housing further comprises a plurality of side slots for dissipating heat.

18. The fuel cell system according to claim 1 wherein a guide board is disposed between the fan and the fuel cell stack.

19. A fuel cell system comprising:
a fuel cell stack consisting of a plurality of fuel cell units, a flow-distributing device, and a flow-confluence device, wherein the plurality of fuel cell units are fixed and sandwiched between the flow-distributing device and the flow-confluence device; and
a fuel container for storing anode fuel, wherein the fuel container has a fuel outlet that is connected to the flow-distributing device and a fuel inlet that is connected to the flow-confluence device.

20. The fuel cell system according to claim 19 wherein the flow-distributing device substantially equally distributes the anode fuel to the plurality of fuel cell units.

21. The fuel cell system according to claim 19 wherein the flow-distributing device and the flow-confluence device fix the fuel cell units and keep substantially equal spacing between the fuel cell units of the fuel cell stack.

22. The fuel cell system according to claim 19 wherein the flow-distributing device comprises a lateral manifold, split-flow conduits and vertical fuel outlets, and wherein the lateral manifold connects with the fuel container.

23. The fuel cell system according to claim 19 wherein the flow-confluence device comprises a plurality of vertical fuel inlets, confluent conduits and confluent fuel outlet, and wherein the confluent fuel outlet connects to the fuel container.

24. The fuel cell system according to claim 19 wherein the fuel container is a reverse-L shaped fuel container.

25. The fuel cell system according to claim 19 wherein the fuel cell units of the fuel cell stack are connected in series or in parallel by wire, welding or circuit integrated with the flow-distributing device and the flow-confluence device.
